(19) United States
(12) Patent Application Publication
(10) Pub. No.: US 2009/0327067 A1
(43) Pub. Date: Dec. 31, 2009

(54) Systems and Methods for Distributing Incentives to Consumers to Encourage Subsequent Action

(75) Inventors: John Berger, Atlanta, GA (US); Douglas P. Dwyre, Castle Rock, CO (US); Todd Parola, Chicago, IL (US)

Correspondence Address: SUTHERLAND ASBILL & BRENNAN LLP, 999 PEACHTREE STREET, N.E., ATLANTA, GA, 30309, US

(73) Assignees: FIRST DATA CORPORATION, Greenwood Village, CO (US); THE LEHIGH PRESS, INC. D/B/A LEHIGH DIRECT, Broadview, IL (US)

(21) Appl. No.: 12/491,716

(22) Filed: Jun. 25, 2009

Related U.S. Application Data
(60) Provisional application No. 61/076,067, filed on Jun. 26, 2008.

(51) Int. Cl. G06Q 30/00

(52) U.S. Cl. 705/14.33; 705/14.1; 705/14.34; 705/14.36

(57) ABSTRACT

Embodiments may relate to systems and methods for distributing incentives to encourage subsequent action. In one embodiment, a method to facilitate encouraging consumer behavior can be provided. The method may include electronically identifying a consumer to be a recipient of an incentive device by a marketing system, wherein the incentive device is associated with a marketing campaign defining at least one predefined activity to be performed by the consumer prior to activating the incentive device, and wherein the incentive device has inherent value that is available for redemption upon activation. The method may further include storing consumer data associating the consumer with the incentive device in the marketing system. In addition, the method may include distributing the incentive device to the consumer in an inactivated state, and electronically activating the incentive device only upon receipt of an indication that the consumer has satisfied the at least one predefined activity.

### CROSS-REFERENCE TO RELATED APPLICATIONS

The present application claims priority to U.S. Provisional Application No. 61/076,067 entitled “Systems and Methods for Distributing Incentives to Consumers to Encourage Subsequent Action” filed on Jun. 26, 2008, which is incorporated herein by reference in its entirety.

### FIELD OF THE INVENTION

The present invention relates generally to incentives, and more particularly to systems and methods for distributing incentives to consumers to encourage subsequent action.

### BACKGROUND OF THE INVENTION

Conventional direct marketing techniques may include distributing incentives, such as gift cards or coupons to customers, or potential customers, to encourage consumer spending and/or to increase customer loyalty. Known direct marketing techniques for encouraging consumer behavior, for instance, to encourage additional spending or in appreciation for their business, may include distributing coupons, active gift cards, or other discounts by mail, or through magazine or newspaper inserts, which may be immediately redeemable by a recipient. In another example direct marketing technique, a mailing may be sent to a consumer to encourage his or her participation in an event or subsequent action, after which a gift card will be distributed to the consumer. In some examples, the mailing may include a mock card that has the appearance of an actual card, but is replaced with an active card after a consumer satisfies the required conditions. Though, in other examples, a simple flyer or advertisement may be distributed, such as by a free standing insert, after which the consumer may receive an actual card. In some techniques, merchants participating in marketing campaigns may hold live card inventories to distribute to consumers upon their satisfying certain criteria, or the cards may be subsequently distributed to the consumers.

Accordingly, there exists a need for systems and methods for distributing incentives to consumers to encourage subsequent action. There exists a further need to more securely distribute incentives to consumers, while also more successfully enticing their participation.

### SUMMARY OF THE INVENTION

Some or all of the above needs and/or problems may be addressed by certain embodiments of the invention. Embodiments of the invention may relate to systems and methods for distributing incentives to encourage subsequent action. In one embodiment, a method to facilitate encouraging consumer behavior can be provided. The method may include electronically identifying a consumer to be a recipient of an incentive device by a marketing system, wherein the incentive device is associated with a marketing campaign defining at least one predefined activity to be performed by the consumer prior to activating the incentive device, and wherein the incentive device has inherent value that is available for redemption upon activation of the incentive device. The method may further include storing consumer data associating the consumer with the incentive device in the marketing system. In addition, the method may include distributing the incentive device to the consumer in an inactivated state, and electronically activating the incentive device only upon receipt of an indication that the consumer has satisfied the at least one predefined activity.

In another embodiment, a system to facilitate encouraging consumer behavior can be provided. The system may include a memory including instructions and operable to store consumer data, and a processor in communication with the memory. The processor may be operable to execute the instructions to store rules associated with a marketing campaign in the memory, wherein the rules define at least one predefined activity to be performed by the at least one consumer prior to activating at least one incentive device, wherein the incentive device has inherent value that is available for redemption upon activation of the incentive device. The processor may further be operable to identify at least one consumer to be a recipient of the at least one incentive device, wherein the at least one incentive device is distributed in an inactive state, and to store consumer data in the memory associating the at least one consumer with the at least one incentive device. The processor may also be operable to receive an indication that the at least one consumer satisfied the at least one predefined activity after the at least one incentive device has been distributed to the at least one consumer, and to activate the at least one incentive device associated with the at least one consumer for which the indication was received only upon receiving the indication.

In yet another embodiment, a method for activating an incentive device can be provided. The method may include receiving an indication that a consumer has performed a predefined activity by a marketing system, wherein the consumer is a recipient of an inactivated incentive device as part of a marketing campaign, wherein the incentive device has inherent value that is available for redemption upon activation of the incentive device, and wherein consumer data associating the consumer with the inactivated incentive device is stored by the marketing system prior to receiving the indication. The method may further include comparing the indication with information associated with the marketing campaign by the marketing system to determine whether to activate the incentive device, and, if the information associated with the marketing campaign indicates that the incentive device should be activated, based at least in part on the performance of the predefined activity, electronically activating the incentive device.

Additional systems, methods, apparatus, features, and aspects are realized through the techniques of various embodiments of the invention. Other embodiments and aspects of the invention are described in detail herein and are considered a part of the claimed invention. Other features can be understood and will become apparent with reference to the description and to the drawings.

### BRIEF DESCRIPTION OF DRAWINGS

Having thus described embodiments of the invention in general terms, reference will now be made to the accompanying drawings, which are not drawn to scale, and wherein:

FIG. 1 illustrates an example functional block diagram of an example system, according to one embodiment of the invention;

FIG. 2 illustrates an example flowchart of an example method, according to one embodiment of the invention; and

FIG. 3 illustrates an example flowchart of an example method, according to one embodiment of the invention.

### DETAILED DESCRIPTION OF EMBODIMENTS OF THE INVENTION

Example embodiments of the invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “incentive device” and “incentives” are used interchangeably, and each may refer to any instrument that may be used as a payment instrument, including, but not limited to, gift cards, prepaid cards, stored value cards, coupons, loyalty or reward cards, or trackable cards. One characteristic of an “incentive device” is that the incentive device has inherent value that is available for redemption upon activation. The example embodiments described below generally refer to “gift cards” for illustrative purposes; however, each of the embodiments is applicable to any incentive device as described or otherwise known.

As used herein, the terms “direct marketer” and “marketer” may be used interchangeably, and each may refer to any entity desirous of encouraging consumer behavior through a marketing campaign. For example, a direct marketer may include, but is not limited to, a retailer, a merchant, a service provider, a wholesaler, a distributor, a financial institution, an institution, and the like. Moreover, a direct marketer may be an entity that may generate a campaign for itself, or on behalf of other entities.

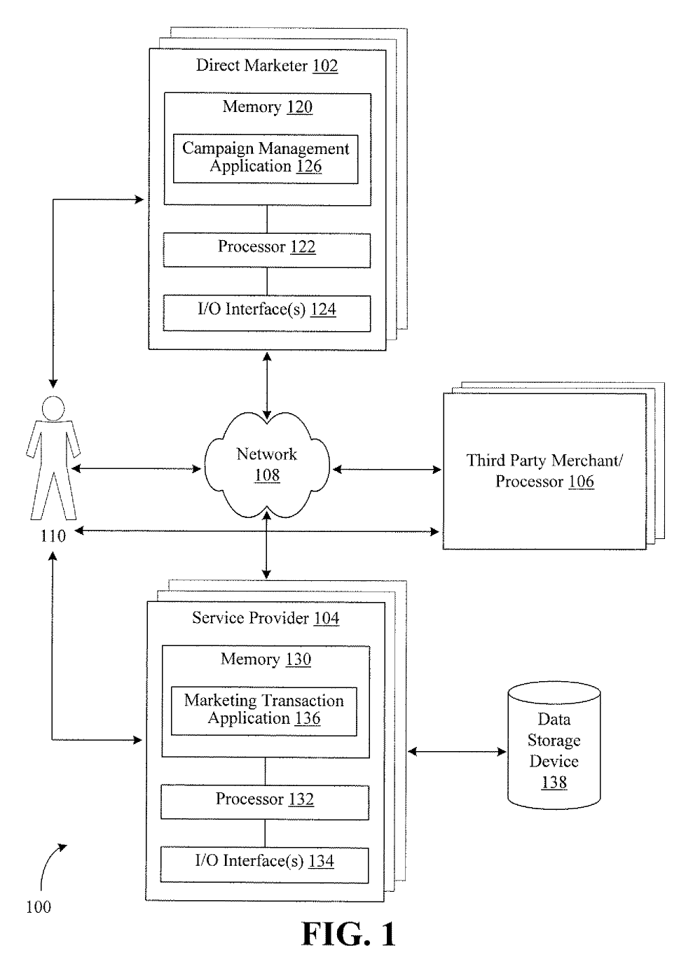

As used herein, the term “electronically” may describe performing an action with, on, controlled by, or aided by one or more of the marketing system components, as described in more detail herein with reference to FIGS. 1-3. Generally, the term electronically may describe actions performed at least in part with, on, by, or aided by a computer, computer network, other processor-driven device, or any combination thereof. The term electronically is not intended to be limiting, and does not exclude operations including magnetic reading, storing, or transmission or optical reading, storing, or transmission of data.

In accordance with example embodiments of the invention, marketing systems and methods for distributing gift cards (or other incentive devices) to encourage subsequent action are provided. Generally, according to example embodiments, these systems and methods securely and conveniently distribute an actual, but inactivated, gift card to consumers to encourage them to perform a predefined activity, which may be defined as part of a marketing campaign. The gift cards may be distributed through one or more distribution channels, such as, but not limited to, through one or more postal services, or through freestanding inserts in newspapers or magazines. Upon performing the predefined activity, the gift card may then be activated and a predetermined balance made available to the consumer for spending according to the associated terms. In addition, each gift card may be associated with a consumer or consumer data prior to distribution. Quite different from the traditional marketing techniques of sending coupons, mock or fake cards, or anonymous cards, embodiments of this invention provide the unique ability to track the gift card promotions from the initial stages of distributing the cards through the consumers performing the predefined activities, activating the cards, and conducting one or more subsequent transactions. Direct marketers, retailers, merchants, card issuers, service providers, and other parties may directly benefit from the information gathered by tracking card activity directly tied with a marketing campaign and an individual recipient. For instance, marketers can identify the various reasons for success or failure by consumer or recipient demographic and/or by delivery channel. Similarly, retailers or merchants can better identify marketing strategies that work best for their consumers, products and/or services purchased in association with each campaign, perform follow-up on consumer recipients who were targeted by a campaign but did not respond, and the like.

Accordingly, a marketing campaign, such as a direct marketing campaign, may be created to identify one or more predefined activities in which a direct marketer would like to encourage consumers participation. The predefined activity may be any activity, such as, but not limited to, providing additional information, visiting a place of business, or attending an event. The direct marketer may then incentives pre-selected consumers to participate by transmitting a gift card to them, which may only be activated upon confirming the consumer's participation in the predefined activity. The gift card may be redeemable or useable with the direct marketer or it may be useable for transactions with a third party, such as a third party merchant or processor, retailer, or service provider, for example.

Embodiments of the invention can provide a competitive edge in direct marketing to consumers. Different from conventional marketing systems, these marketing systems and methods greatly reduce opportunities for fraudulent activities, such as theft of activated gift cards in the mail or from retailer inventories. Furthermore, example embodiments may better align with accounting systems and avoid unnecessary inventory of active cards having an actual balance associated therewith. Additionally, consumer and/or merchant behavior may be better tracked and reported because actual gift cards, which are later used during purchase transactions, are encoded or otherwise associated with consumer information, merchant information, and the like, and distributed to consumers upon initial contact.

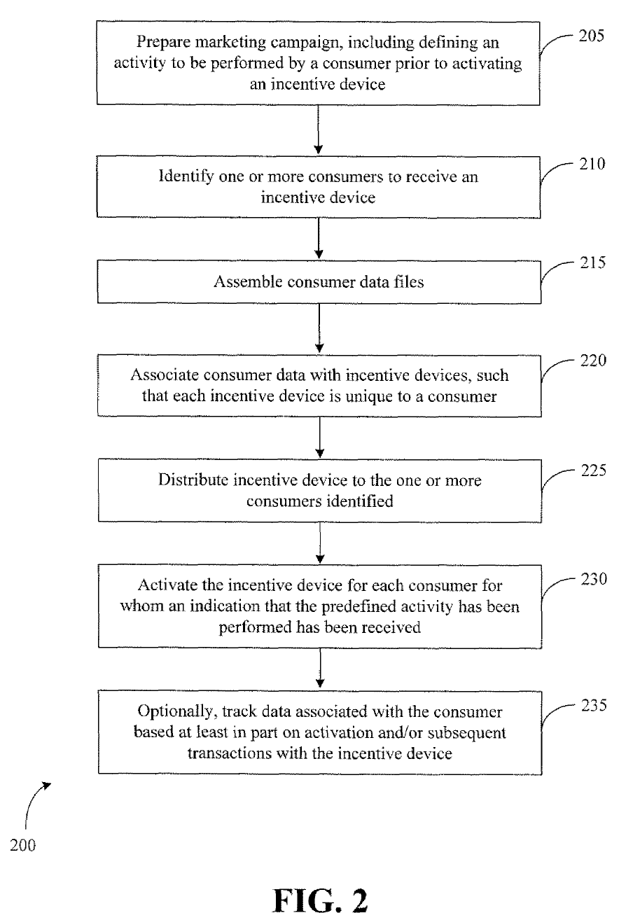

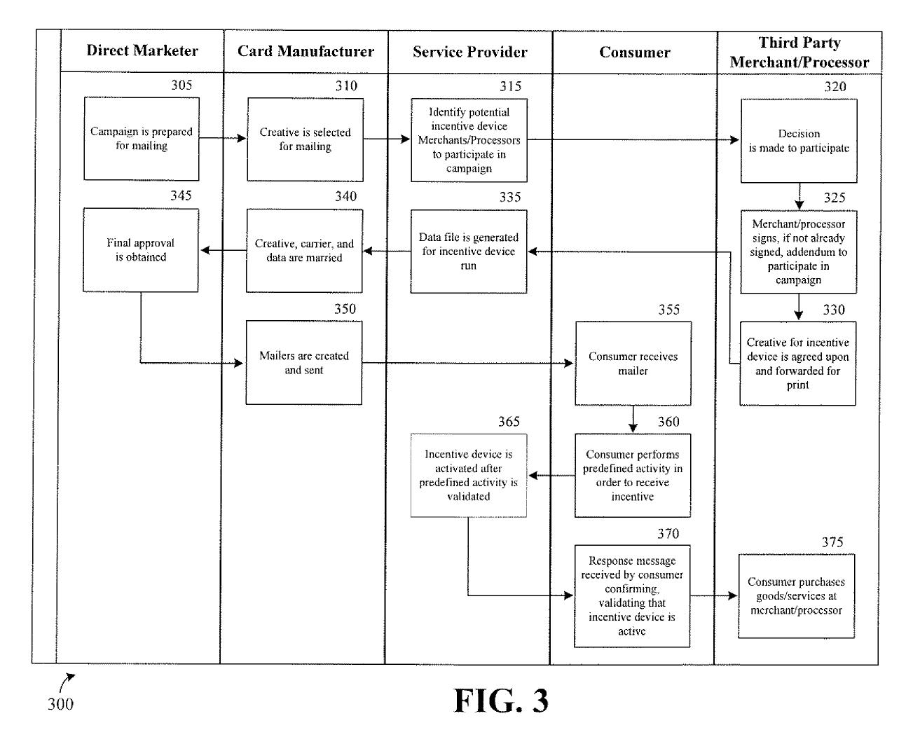

FIG. 1 shows a schematic diagram of one example system 100 to provide a direct marketing campaign that encourages consumer behavior, according to an example embodiment of the invention. For example, the system 100 may be a marketing system utilized to distribute inactive gift cards (or other incentive devices) to a consumer that require the consumer to perform one or more predefined activities before the incentive device is activated for the consumer's use. Various entities may participate in creating, preparing, and/or executing the systems and methods described herein for direct marketing. In one example embodiment, a direct marketer, a service provider, one or more third party merchants or processors, and one or more consumers may be included, as illustrated in FIG. 1. Entities in addition to those illustrated in FIG. 1 may participate in other example embodiments, such as a card manufacturer as more fully described below with reference to FIGS. 2-3. Moreover, it is appreciated that any of the described functions may be performed by one or more of the other entities according to other example embodiments.

Each of these entities may be associated with and/or operate one or more processor-based systems, allowing them to execute one or more of the below-described features. In one example embodiment, as illustrated in FIG. 1, the system 100 may include at least one direct marketer 102, at least one service provider and/or card manufacturer 104, at least one third party merchant or processor 106, and respective associated processor-based systems. Each of the direct marketer 102, the service provider 104, and/or the third party merchant or processor 106 may optionally be in communication over a network 108. Furthermore, the example system 100 additionally includes one or more consumers 110 which may interact with the one or more of the entities, directly, through the network 108, through mailings, telephone communications, cellular communications, and/or any combination thereof. As used herein, the term “marketing system” may generally refer to any or all of the components illustrated in FIG. 1 and described with reference thereto, and should not be construed as being limited to the direct marketer or the direct marketer system.

With reference to FIG. 1, the direct marketer system 102 may include any system or systems operable to perform marketing and/or marketing campaign functions, such as activities including, but not limited to, preparing associated materials and campaign rules, managing and reporting on associated campaign programs and consumer activities, or communicating with other entities, such as a service provider or a third party merchant or processor. The direct marketer system 102 may include any processor-driven device or devices such as, but not limited to, a server computer, a mainframe computer, networked computers, a personal computer, a mobile computer, a handheld portable computer, a desktop computer, a laptop computer, or any other processor-based device. The direct marketer system 102 may include at least one memory 120, processor 122, and one or more input/output (“I/O”) interfaces 124. The memory 120 may store data files and/or one or more database management systems (“DBMS”), and various program modules, such as a campaign management application program 126. The memory 120 may also include an operating system (“OS”), such as, but not limited to, Microsoft Windows®, Apple OSX™, or Linux.

The campaign management application 126 may provide instructions for electronically receiving, processing, altering, generating, and/or transmitting data or other communications associated with preparing and/or maintaining a marketing campaign, as described in more detail herein. For example, the campaign management application 126 may be used to electronically identify consumers which may be recipients of a gift card distributed in response to a campaign, or to define other campaign rules, such as predefined activities and other limitations associated with a campaign. The campaign management application 126 may additionally operate in conjunction with one or more of the I/O interfaces 124 to facilitate communication with one or more other components of the system 100, such as a service provider 104 and/or a third party merchant or processor 106, over the network 108.

The I/O interfaces 124 may facilitate communication with one or more input/output devices, for example, a display, keyboard, keypad, mouse, control panel, touch screen display, microphone, and the like, that facilitate user interaction with the direct marketer system 102. The one or more input/output devices may be utilized to collect information from and display information to any user of the direct marketer system 102, for example, a campaign manager or a marketing agent. The I/O interfaces 124 may also facilitate connection of the direct marketer 102 to one or more suitable networks 108, such as may be used when communicating with one or more of the other entities.

In addition to those described herein, other components may be included in the direct marketer system 102 as desired in various embodiments of the invention.

With reference to FIG. 1, the service provider 104 may similarly include any system or systems operable to provide gift card capabilities, including, but not limited to, incentive device manufacturing, distribution, activation, update, account maintenance, reporting, transaction processing, and the like. Moreover, the service provider 104 may further include any system or systems operable to aid in marketing functions, such as maintaining consumer data, verifying consumer activities against marketing campaign rules or conditions, reporting, and the like. For simplicity, the service provider 104 is described as performing functions associated with card manufacturing, distribution, and account maintenance; however, it is appreciated that in other embodiments, one or more of these functions may be performed separately by a card manufacturer, or any other entity, such as a card issuer (which may be also be referred to herein as a “financial institution”).

The service provider 104 may include any processor-driven device or devices such as, but not limited to, a server computer, a mainframe computer, networked computers, a personal computer, a mobile computer, a handheld portable computer, a desktop computer, a laptop computer, or any other processor-based device. The service provider system 104 may include at least one memory 130, processor 132, and one or more input/output (“I/O”) interfaces 134. The memory 130 may store data files and/or one or more database management systems (“DBMS”), and various program modules, such as a marketing transaction application program 138. The memory 130 may also include an operating system (“OS”), such as, but not limited to, Microsoft Windows®, Apple OSX™, or Linux.

The marketing transaction application 136 may provide instructions for electronically receiving, processing, altering, generating, and/or transmitting data or other communications associated with a marketing campaign, such as to aid in maintaining consumer data, activating incentive devices, tracking gift card transactions, reporting, and the like. For example, the marketing transaction application 136 may be used to receive indications associated with a consumer having performed one or more predefined activity, compare the consumer and/or the activity indication to information associated with a marketing campaign, such as campaign rules, activate gift cards, track consumer activities, reporting, and the like, as well as typical gift card transaction functions, such as balance inquiries, fund management, account management, personal identification number management, transaction processing, and the like. The marketing transaction application 136 may additionally operate in conjunction with one or more of the I/O interfaces 134 to facilitate communication with one or more other components of the system 100, such as a service provider 104 and/or a third party merchant or processor 106, over the network 108.

The I/O interfaces 134 may facilitate communication with one or more input/output devices, for example, a display, keyboard, keypad, mouse, control panel, touch screen display, microphone, bar code readers/scanners, card manufacturing and packaging devices, and the like, that facilitate user interaction with the service provider system 104. The one or more input/output devices may be utilized to collect information from and display information to any user of the service provider system 104. The I/O interfaces 134 may also facilitate connection of the service provider 104 to one or more suitable networks 108, such as may be used when communicating with one or more of the other entities.

The service provider 104 may optionally include or be in communication with at least one data storage device 138. The data storage device 138 may include one or more database management systems (“DBMS”) operable to store, for example, consumer data, gift card information, such as account data, reporting information, marketing campaign information, and the like. Although a single data storage device 138 is referred to herein for simplicity, in other example embodiments multiple physical and/or logical data storage devices 138 or databases may be used to store the above mentioned data. For security and performance purposes, the service provider 104 may have a dedicated connection to the data storage device 138. However, the service provider 104 may also communicate with the data storage device 138 via a network 108. In other embodiments, the service provider 104 may include the data storage device 138 locally, such as in the memory 130. It is further appreciated that, although not illustrated, any or all of the other system components may similarly include a DBMS.

In addition to those described herein, other components may be included in the service provider system 104 as desired in various embodiments of the invention.

Still with reference to FIG. 1, the example system may optionally include one or more third party merchants or processors 106. A third party merchant or processor system 106 may include any number of suitable processing systems and/or processing devices in communication with one or more of the direct marketers 102, and/or the service providers 104, such as by communicating through one or more networks 108. In one example embodiment, the third party merchant or processor 106 may be or be associated with an entity at which the gift cards (or other incentive devices) distributed as part of a marketing campaign can be redeemed.

Generally, each of the memories 120, 130, the data storage device 138, and any other data storage devices or databases, can store data and information for subsequent retrieval. In this manner, the system 100 can store various received or collected information in memory or a database associated with a direct marketer 102, a service provider 104, and/or a third party merchant or processor 106. The memories 120, 130, the data storage device 138, and any other data storage devices or databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments the data storage device 138 and/or any other database can be integrated or distributed into any number of databases or data storage devices residing in association with one or more of the systems in the overall system 100.

Suitable processors for a direct marketer 102, a service provider 104, and/or a third party merchant or processor 106 may include a microprocessor, an ASIC, and state machine. Example processors can be those provided by Intel Corporation (Santa Clara, Calif.), AMD Corporation (Sunnyvale, Calif.), and Motorola Corporation (Schaumburg, Ill.). Such processors include, or may be in communication with media, for example computer-readable media, which stores instructions that, when executed by the processor, cause the processor to electronically perform the elements and/or functions described herein. Embodiments of computer-readable media include, but are not limited to, an electronic, optical, magnetic, or other storage or transmission device capable of providing a processor, such as processors 122, 132, or any other processors, for example those in used by the third party merchant or processor 106, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can electronically read instructions. Also, various other forms of computer-readable media may electronically transmit or carry instructions to a computer, including a router, private or public network, or other transmission device or channel, both wired and wireless. The instructions may include code from any computer-programming language, including, for example, C, C++, C#, Visual Basic, Java, Python, Perl, and JavaScript. Furthermore, any of the processors 122, 132, or any other processors, may operate any operating system capable of supporting a browser or browser-enabled application including, but not limited to, Microsoft Windows®, Apple OSX™, and Linux.

The one or more networks 108 may include any telecommunication and/or data network, whether public, private, or a combination thereof, including a local area network, a wide area network, the Internet, an internet, a telephone network, a cellular network, intermediate hand-held data transfer devices, and/or any combination thereof and may be wired and/or wireless. The network 108 may also allow for real-time, off-line, and/or batch transactions to be transmitted between the each of the systems. Due to network connectivity, various methodologies as described herein may be practiced in the context of distributed computing environments.

One skilled in the art may recognize the applicability of embodiments of the invention to other environments, contexts, and applications. One will appreciate that components of the system 100 shown in and described with respect to FIG. 1 are provided by way of example only. Numerous other operating environments, system architectures, device configurations, and data flows are possible. Accordingly, embodiments of the invention should not be construed as being limited to any particular operating environment, system architecture, device configuration, or data flow.

Embodiments of a system, such as the system 100, can be provided to facilitate marketing campaigns. More specifically, one or more marketing campaigns to encourage consumer behavior, such as participating in one or more predefined activities prior to activating an incentive device, can be achieved by way of implementation of various embodiments of the system 100, and methods described herein. Example methods and processes which can be implemented with the example system 100, as well as other system embodiments, are described by reference to FIGS. 2-3.

FIG. 2 illustrates an example method 200 providing a summary description of a process for creating, distributing, and activating one or more gift cards (or other incentive devices) as a part of a marketing campaign, according to one embodiment of the invention. A marketing system, such as the system 100 as described with reference to FIG. 1, may be used to perform or facilitate the performance of one or more of the features described with reference to the method 200.

The method 200 begins at block 205, in which a marketing campaign may be prepared by or for a direct marketer, such as a merchant, retailer, service provider, or other party attempting to encourage certain consumer behavior. As part of preparing the marketing campaign, a predefined activity, to be performed or condition to be met prior to activating the distributed gift cards, is defined. A predefined activity may be any activity, such as providing information or requiring subsequent participation with the direct marketer or at a place of business. Example predefined activities may include, but are not limited to, test driving an automobile, visiting a sale event, purchasing a product, obtaining a quote for a service, opening an account, viewing a demonstration, providing consumer information, participating in a consumer survey, or the like. In one example embodiment, a predefined activity may require the consumer to perform an action through a website, such as to provide additional consumer information, complete a survey, use a product or service, and the like, which upon completion, the gift card or other incentive may be activated for the consumer. It is appreciated that the marketing campaign may be identified, planned, and prepared by the direct marketer, or by any other party, such as by a marketing or advertisement firm. A marketing system may be used to facilitate preparing the marketing campaign, such as by using campaign planning and management software applications, and by storing data associated with the campaign, such as predefined activities and/or other conditions and rules, and the like.

After block 205 is block 210, in which the consumers who will receive the gift card distributions are identified. As used herein, “identifying consumers” (and similar terms and phrases) may refer to performing an initial selection or determination of consumer recipients or receiving consumer recipient information from one or more third parties that have performed an initial determination. For example, the consumer data may be initially determined by a third party marketer, and transmitted or otherwise provided to the direct marketer system 102; whereby the campaign management application 126 (or another component of the marketing system 100) may then effectively identify consumers or consumer data by selecting one or more elements of information transmitted by the third party. In another example, however, the campaign management application 126 (or another component of the marketing system 100) may perform the initial determination of the consumers, for instance by using one or more consumer analytics tools and consumer data available or otherwise obtained. Additionally, in one example embodiment, the consumer may opt-in to the campaign or otherwise indicate a preference to receive a gift card distributed as part of the campaign. For example, a consumer may register to be a recipient on a website, at a physical location, or may respond to a mailing or advertisement, such that the direct marketer 102 or the service provider 104 (or another component of the marketing system 100) effectively identifies the consumers as a result of receiving the opt-in request directly from one or more consumers. Accordingly, the term “identify” is not limited to an initial determination, and can also, or instead of, mean receiving previously determined information.

In one embodiment, consumers may be identified by the direct marketer when developing the marketing campaign. In another embodiment, the consumers may be identified at least in part by one or more service providers working in cooperation with a direct marketer. Furthermore, in other embodiments, one or more third parties, such as a marketing firm, may participate in the determination of the consumers to be recipients of gift cards in association with the marketing campaign. One or more marketing systems may aid in the identification of consumers, such as by performing processing, sorting, filtering, and/or applying rules to potential recipient lists, and the like.

Following block 210 is block 215, in which data associated with consumers who are identified as recipients of the gift card mailings, for example in block 210, may be assembled into one or more consumer data files. The direct marketer may have existing data on some or all of the consumer recipients. In other example embodiments, consumer data may be obtained from another source, such as from a service provider, a third party merchant or processor, or any other entity having access to consumer data, such as customer lists. The consumer data file may include consumer information, such as name, address, consumer identification number or account number, or specific limitations associated with the consumer. The consumer information contained in the consumer data files may further be utilized by one or more of the participating entities for tracking and/or reporting, such as for tracking consumer spending or other consumer behaviors, as well as for tracking effectiveness of associated marketing campaigns and distribution channels. In one embodiment, this consumer information may be maintained by one or more service providers. For example, if maintained by one or more service providers, the consumer data file may be stored in a data storage device, such as a data storage device 138 as described with reference to FIG. 1. However, in other embodiments, other entities, such as the third party merchant or processor, a card manufacturer, or other third parties, may maintain this information. The consumer information, which may optionally include account information, may be used while performing transactions with the card, such as during activation, funding, or purchasing, for example.

Following block 215 is block 220, in which the consumer information stored in the data file is associated with the gift cards, such that each gift card is associated with or includes information that is unique to one consumer recipient. For example, in one embodiment, a consumer data file may store consumer information and an association between each consumer and one or more gift cards, such that a link between the transactions conducted using the gift card can ultimately be associated with a consumer. In another embodiment, the gift card may have consumer information printed and/or stored thereon, such as a consumer's name, a consumer's own pre-existing account number, and the like. Accordingly, the consumer data file, such as that stored and maintained by a marketing system, may include an association between the consumer recipient's and the respective gift card or cards intended for distribution.

According to one example embodiment, the gift cards may be paper-based or plastic-based cards. In one example, data may be stored on or otherwise associated with the gift cards at substantially the same time as the gift cards are manufactured and/or prepared for mailing. In another example, data may be stored on or otherwise associated with the gift cards at a later time. Data may be stored on or otherwise associated with the gift cards through conventional techniques, such as magnetic strip, bar code, three-dimensional bar code, and/or in a radio frequency identification device (“RFID”) enabled microchip.

Consumer data may be directly stored on the card, or in some embodiments associated with a unique identifier that is stored on the card, such that the unique identifier allows retrieval of information in the consumer data file upon use of the card, such as by communicating with the service provider or other entity having access to consumer data, for example. The unique identifier may be an account number, which may be displayed with other indicia on the face of the card, or it may be another number, which may only be stored on the card but not visibly displayed. Furthermore, the unique identifier, or information associated with the consumer data stored remotely, may be provide references to other systems, such as account systems, customer relationship management systems, or analytics systems, for example, and may be used while processing transactions with the card and/or when tracking consumer behavior or reporting on marketing campaign activity.

Additional data may be associated with or stored on the gift cards. For example, data regarding the merchant information where the card is redeemable, such as store limitations, stored value amount, or expiration dates may be associated with each card. Additionally, during the manufacturing process, the gift card may include trade mark or service mark indicia, consumer recipient information, stored value amount, expiration date, or limitations and exclusions, for example, on one or more faces of the card.

Following block 220 is block 225, in which the gift cards are prepared for distribution to the consumers. The cards may be prepared for traditional distribution channels, such as through one or more postal services, using a card mailer or carrier, or through freestanding inserts in newspapers or magazines, as is known. A marketing system may be used to facilitate the distribution of the gift cards. For example, a marketing system may generate a signal or signals that indicate when certain gift cards are ready for distribution. In another example, a marketing system may generate recipient lists, distribution instructions, coordinate and/or track the distribution, and the like.

When distributing the gift cards to the consumer recipients, the predefined activity to be performed and/or other conditions to be met may be included in the distributed materials. For example, the gift card or the gift card mailer or carrier may explain the terms for activating the card, such as describing any of the predefined activities described above.

The gift cards or other incentive devices will have an inherent value upon distribution to the customers, which, upon activation of the incentive device (such as in block 230), the inherent value is available for redemption. Any type of inherent value can be associated with the card and redeemable, including, but not limited to, monetary value, discount value, coupon, free goods, free services, additional offers, and the like. It is appreciated that the type of value associated with the gift cards is not intended to be limiting, and that an entity can define any type of value as desired.

Following block 225 is block 230, in which after receiving an indication that a consumer has performed a predefined activity, and/or satisfied any other conditions, the gift card distributed to that consumer may be activated by the service provider. Upon activation, the inherent value associated with the gift card will be available for redemption by the consumer.

In one example embodiment, the indication may include an account number or other unique identifier associated with the gift card and information identifier the consumer. Though in other embodiments, the indication may simply include the account number, requiring the service provider to identify the associated consumer by performing an inquiry into the consumer data assembled and stored, for example in block 215, based on the account number. In yet another embodiment, the indication may simply include consumer information, and the service provider may then identify the associated gift card by performing an inquiry into the consumer data. In example embodiments, the indication may be received by a marketing system over a network, such as the network 108 as described with reference to FIG. 1. The marketing system and its associated applications may then be used to process the indication and facilitate activation of the associated gift card.

Activation may be by any means known. For example, a marketing system may electronically activate one or more gift cards, such as by updating PIN data, activating card numbers in an account database, associating a stored value amount with the card, and the like. Furthermore, while activation is described herein generally as being performed by a service provider, in other embodiments activation may be performed by a direct marketer, a third party merchant or processor, by other third parties participating in the process, such as a financial institution like the a gift card issuer, and/or any combination thereof. For example, in an embodiment where all or part of the predefined activity is an online process, such as completing an online survey, the activation may be automated when the consumer fulfills their obligation online, such that an update at the service provider (or other party) activates the card. In other example embodiments, the card may be activated by a telephone call placed to an agent, through an interactive voice response unit (“IVR”), by network-based activation, at a kiosk, or at a point of sale terminal (“POS”). Moreover, in example embodiments, an agent or representative associated with the direct marketer may communicate with the service provider (or other party) through any of these means, for example, to activate the gift card upon observing or confirming the consumer's satisfaction of the predefined activity and/or other conditions. Upon activation or otherwise shortly thereafter, the gift card may be ready for immediate use by the consumer.

Optionally following block 230 is block 235, in which activities associated with consumer's behavior may be tracked by a marketing system, based at least in part on activation of a gift card and/or conducting transactions with a gift card. Because the actual gift card that is activated and used by the consumer is distributed at the initial point of contact, the direct marketer, the third party merchant or processor, and/or the service provider may track the consumer's behavior at all points in the campaign process. Such a complete reporting of the consumer behavior may allow the interested parties to identify individual, demographic, geographic, and other factors affecting the success of the marketing campaign. Moreover, being able to identify consumer recipients that have not yet performed the predefined activity, activated, and/or spent the gift card allows interested parties, such as the direct marketer 102, the service provider 104, or the associated merchant, to follow-up with and/or continue to monitor those consumer recipients' behaviors. The tracking and reporting may be done in real-time and/or on a near-real time basis. Furthermore, the tracking and reporting data on individual consumers or pre-defined consumer groups may be used to update existing analytic tools, such as customer relationship management data, or consumer loyalty systems.

The method 200 may end after block 235, having activated a gift card (or other incentive device) distributed to a consumer only after having received indication that the consumer performed a predefined activity and/or other conditions required as part of the associated marketing campaign.

FIG. 3 illustrates another example method 300 providing a more detailed description of an example process for creating, distributing, and activating gift cards (or other incentive devices), according to one embodiment of the invention. As illustrated, this example method may include a direct marketer, a card manufacturer, a service provider, one or more consumers, and one or more third party merchants or processors at which the gift card may be redeemable. It is appreciated that these parties are identified as example participants in the process, and that not all parties are necessary. For example, in embodiments in which the gift card or other incentive is redeemable at the direct marketer, the third party merchant or processor may not be necessary. In other embodiments, the card manufacturer and the service provider may be the same entity. It is also appreciated that additional entities may be included. For example, the direct marketer may utilize additional third party advertisement or marketing organizations to prepare the marketing campaign, the service provider or direct marketer may use third party consumer analytics and/or data organizations to identify consumers and/or prepare consumer data for mailing, or the card manufacturer or service provider may utilize additional entities to perform some of the elements described.

This example method 300 begins at block 305, in which a direct marketer prepares a campaign for distributing a gift card to one or more consumers. As described above, part of preparing the campaign includes identifying one or more predefined activities or other conditions which must be met by consumer recipients before the distributed gift cards are activated.

Following block 305 is block 310, in which the mailing or “creative” may be prepared and/or selected for distribution to the consumers. This may include an envelope, an incentive advertisement stuffer, a free standing insert in a newspaper or magazine, a single piece card and carrier, and the like. The carrier includes may include the terms of the predefined activity, such as the steps to be satisfied prior to activating the gift card, and/or other conditions. Other limitations, exclusions, expiration dates, stored value amounts, participating locations, and the like may also be included on or with the carrier.

Following block 310 is block 315, in which one or more third party merchants or processors, retailers, or service providers, for example, may be selected, at which the distributed gift card or incentive is redeemable. In one example embodiment, the gift card may be redeemable at the direct marketer, such as for transacting purchases with the direct marketer, and another third party merchant or processor may not be selected. In another example embodiment, the gift card may be redeemable at a merchant, retailer, or service provider other than the direct marketer, but funded by the direct marketer. In other example embodiments, the third party merchant or processor may be a financial institution that provides stored value cards that are redeemable at more than one location, such as an open loop gift card.

Following block 315 are blocks 320 and 325, in which the third party merchant or processor may make a decision to participate in the marketing campaign, and signs certain papers, such as legal documents, program terms, card limitations, and the like, respectively.

Following block 325 is block 330, in which the creative or mailing and/or the gift card design may be approved by the third party merchant or processor.

Following block 330 is block 335, in which consumer data, merchant data, reporting data, and the like, is assembled, as described above. As part of this step, the consumers recipients may be identified as more fully described above with reference to FIG. 2. The consumer data, such as the consumer data, may be stored on the card to aid in transactions, redemption, tracking, reporting, and the like. The consumer data may also be stored locally with one or more of the participating entities, such as the direct marketer, the service provider, or the card manufacturer, for example.

Following block 335 is block 340, in which the card carrier is manufactured by the card manufacturer and data, such as the consumer data, third party merchant or processor data, card data, may be stored thereon or otherwise associated therewith. As described above, it is appreciated that in some example embodiments, the card manufacturer and the service provider may be the same entity, or that additional entities or organizations not illustrated may also be included in the process. In one example, the carrier may be manufactured such that the gift card and the mailer is a paper-based product produced in an inline production process, providing simplicity and efficiency in the manufacturing process. Data stored on each card, for example consumer-specific data, merchant data, and/or card data, such as account data, may be compiled as a single data file and stored on the card during the same inline card manufacturing process, such as with technologies such as a magnetic strip, bar code, three-dimensional bar code, and/or RFID microchip.

Block 345 follows block 350, in which the marketing campaign, and its associated components are optionally approved by participating parties. For example, the direct marketer and/or the merchant may approve at least one of the consumer recipient list, the card and carrier design, the information transmitted, and/or the program terms.

Following block 350 is block 355, in which the gift cards are distributed to the consumers identified as recipients for the marketing campaign. It is appreciated that for all of the reasons as described above, distributing an actual, but not activated gift card, avoids the risks of fraudulent activities, theft, inventory loss, and the like. Furthermore, a consumer receiving an actual gift card, such as with their name, and the actual stored value, may be more incentivized to participate in the campaign. As occurs at block 355, upon receiving the gift cards and carriers, the consumer recipients are able to review the predefined activity and/or other conditions required as part of the marketing campaign, the stored value amount on the gift card, and may thus be more encouraged to participate in the campaign by satisfying the predefined activity and/or other conditions.

Following block 355 is block 360, in which the consumer may perform one or more of the activities predefined by the direct marketer in order to activate the gift card and redeem the stored value amount. The predefined activities may be any activity, for example those described herein, that are deemed to be valuable to the direct marketer, and for which the direct marketer desires increased consumer participation. Accordingly, providing an incentive to the consumer prior to the consumer performing any action may create an additional incentive or means of encouragement for their participation in the campaign. Moreover, because the gift card or other incentive may be immediately activated upon their satisfying the pre-condition, the consumers may be more incentivized to participate in the predefined activity than in conventional systems whereby a consumer may have to wait to receive an actual gift card or may have to perform yet additional steps, such as network-based registration, or surveys, for example. Additionally, in some embodiments, the direct marketers and/or the third party merchants or processors may prefer the consumer possess the actual card at the time of performing the predefined activity, because there may be an increased likelihood that the consumers immediately redeem the gift cards with the direct marketer or third party merchant or processor, thus encouraging additional consumer spending and/or consumer loyalty.

Following block 360 is block 365, in which the gift card may be activated by the service provider after receiving an indication that the predefined activity has been performed. In other example embodiments, the card may be activated by the direct marketer, the third party merchant or processor, the service provider, the consumer, or any combination thereof, as is more fully described with reference to FIG. 2.

In example embodiments, the consumer may receive a response message that the card has been activated, such as is described at block 370. For example, if being activated at a kiosk, an IVR, or a POS terminal at a store location, for instance, at the direct marketer or an event associated therewith, a confirmation message may be returned. In other embodiments, the consumer may receive an email, an Internet-based message or webpage, an SMS text message, a mailing, a telephone message, or the like, upon activation of the card. It is also appreciated that other parties, such as the service provider, the direct marketer, and/or the third party merchant or processor may receive a confirmation message that the card has been activated, indicating that the consumer has satisfied the pre-conditions. The confirmation messages may be transmitted in real-time or near real-time.

Following block 370 is block 375, in which the consumer may optionally conduct a transaction at the third party merchant, or with a processor (or other entity), using the gift card after it is activated, as is known. The gift card (or other incentive device) may be a single use gift card or may be a multi-use gift card, allowing subsequent transactions until the balance is depleted, and/or may be a reloadable gift card by which additional funds may be added to restore or increase the balance.

The method 300 may end after block 375, having activated a gift card (or other incentive device) distributed to a consumer only after having received indication that the consumer performed a predefined activity and/or other conditions required as part of the associated marketing campaign.

As described herein, these systems and methods do not require the consumer to wait to obtain a separate active or live gift card, as in conventional systems, because the consumer already possesses the actual card that can be subsequently activated. Furthermore, because retailers, merchants, service providers, or any other party acting as the direct marketer do not hold live, activated cards in their inventory, fraudulent activities, such as theft by employees or during distribution are avoided. In addition, the direct marketer does not have to maintain an inventory of fully funded cards, which may be depleted and thus unavailable to consumers who satisfy the conditions.

Furthermore, because the gift cards or other incentives are targeted specifically to individuals, the terms of the incentive may differ per consumer or consumer groups. For example, the predefined activity may differ, the third party merchant or processor at which the gift card is redeemable may differ, or the stored value amount may differ. Accordingly, the direct marketer may make more strategic decisions as to the type of merchant, the stored value amount, the pre-condition, or the like, based on existing consumer data or analytics results, to further increase the effectiveness of the incentive and the consumer's participation with the direct marketer while minimizing the required costs associated with the marketing campaign.

The operations described and shown in the methods of FIGS. 2-3 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 2-3 may be performed.

The invention is described above with reference to block diagrams and flowchart illustrations of systems, methods, apparatuses and computer program products according to embodiments of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions above.

These computer program instructions may also be stored in a computer readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams and flowchart illustrations support combinations of means for performing the specified functions, combinations of elements or steps for performing the specified functions and program instruction means for performing the specified functions. It will also be understood that each block of the block diagrams, and combinations of blocks in the block diagrams, can be implemented by special purpose hardware-based computer systems that perform the specified functions, elements or steps, or combinations of special purpose hardware and computer instructions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method to facilitate encouraging consumer behavior, comprising:
electronically identifying a consumer to be a recipient of an incentive device by a marketing system, wherein the incentive device is associated with a marketing campaign defining at least one predefined activity to be performed by the consumer prior to activating the incentive device, and wherein the incentive device has inherent value that is available for redemption upon activation of the incentive device;
storing consumer data associating the consumer with the incentive device in the marketing system;
distributing the incentive device to the consumer in an inactivated state; and
electronically activating the incentive device upon receipt of an indication that the consumer has satisfied the at least one predefined activity.

2. The method of claim 1, receiving campaign information from another entity associated with the marketing campaign.

3. The method of claim 1, wherein the at least one predefined activity comprises at least one of providing information, visiting a location, making a purchase, using a product, using a service, or attending an event.

4. The method of claim 1, wherein the at least one predefined activity is performed at least in part using the Internet, over a telephone, using an interactive voice response system, at a merchant location, or at a self-service kiosk.

5. The method of claim 1, further comprising notifying the consumer that the incentive device is activated concurrent with or subsequent to activating the incentive device.

6. The method of claim 1, further comprising receiving a request on behalf of the consumer to participate in the marketing campaign, wherein the consumer is electronically identified to be a recipient of the incentive device based at least in part on the request.

7. The method of claim 1, wherein the incentive device comprises indicia identifying the consumer.

8. The method of claim 1, wherein the incentive device comprises a unique identifier, and further comprising electronically identifying the consumer by the marketing system, based at least in part on the unique identifier, prior to activating the incentive device.

9. The method of claim 1, further comprising storing information associated with the consumer in the marketing system based at least in part on electronically activating the incentive device.

10. The method of claim 1, further comprising storing information associated with the consumer in the marketing system based at least in part on at least one subsequent transaction associated with the incentive device.

11. The method of claim 1, wherein the incentive device comprises a gift card.

12. A system to facilitate encouraging consumer behavior, comprising,
a memory comprising instructions and operable to store consumer data; and
a processor in communication with the memory, wherein the processor is operable to execute the instructions to:
store rules associated with a marketing campaign in the memory, wherein the rules define at least one predefined activity to be performed by the at least one consumer prior to activating at least one incentive device, and wherein the at least one incentive device has inherent value that is available for redemption upon activation of the at least one incentive device;
identify at least one consumer to be a recipient of the at least one incentive device, wherein the at least one incentive device is distributed in an inactive state;
store consumer data in the memory associating the at least one consumer with the at least one incentive device;
after the at least one incentive device has been distributed to the at least one consumer, receive an indication that the at least one consumer satisfied the at least one predefined activity; and
activate the at least one incentive device associated with the at least one consumer for which the indication was received only upon receiving the indication.

13. The system of claim 12, wherein the processor is her operable to compare the indication received to the rules prior to activating the at least one incentive device.

14. The system of claim 12, wherein the processor is further operable to receive the rules associated with the marketing campaign from another entity associated with the marketing campaign.

15. The system of claim 12, wherein the at least one predefined activity comprises at least one of providing information, visiting a location, making a purchase, using a product, using a service, or attending an event.

16. The system of claim 12, wherein the processor is further operable to:
receive a request on behalf of the at least one consumer to participate in the marketing campaign; and
identify the at least one consumer to be a recipient of the at least one incentive device based at least in part on the request.

17. The system of claim 12, wherein the incentive device comprises indicia identifying the consumer.

18. The system of claim 12, wherein the indication received by the processor comprises a unique identifier associated with the at least one incentive device and the at least one consumer, and wherein the processor is further operable to identify the at least one consumer, based at least in part on the unique identifier, prior to activating the incentive device.

19. The system of claim 12, wherein the processor is further operable to store information associated with the consumer in the memory based at least in part on activating the incentive device.

20. The system of claim 12, wherein the processor is further operable to store information associated with the consumer in the memory based at least in part on at least one subsequent transaction associated with the incentive device.

21. A method for activating an incentive device, comprising:
receiving an indication that a consumer has performed a predefined activity by a marketing system, wherein the consumer is a recipient of an inactivated incentive device as part of a marketing campaign, wherein the incentive device has inherent value that is available for redemption upon activation of the incentive device, and wherein consumer data associating the consumer with the inactivated incentive device is stored by the marketing system prior to receiving the indication;
comparing the indication with information associated with the marketing campaign by the marketing system to determine whether to activate the incentive device; and
if the information associated with the marketing campaign indicates that the incentive device should be activated, based at least in part on the performance of the predefined activity, electronically activating the incentive device.

22. The method of claim 21, wherein the indication that the consumer has performed the predefined activity comprises at least one of information identifying the consumer.

23. The method of claim 21, wherein the indication that the consumer has performed the predefined activity comprises a unique identifier associated with the incentive device, and wherein comparing the indication with information associated with the marketing campaign further comprises electronically identifying the consumer from the consumer data stored by the marketing system based at least in part on the unique identifier.
